(19) United States
(12) Patent Application Publication
(10) Pub. No.: US 2025/0373916 A1
(43) Pub. Date: Dec. 4, 2025

(54) LENS DEVICE

(71) Applicant: Asia Optical Co., Inc., Taichung (TW)

(72) Inventors: Po-Jen Wang, Taichung (TW); Chi-Chu Liu, Taichung (TW)

(21) Appl. No.: 19/198,178

(22) Filed: May 5, 2025

(30) Foreign Application Priority Data
May 31, 2024 (TW) 113120260
Dec. 20, 2024 (CN) 202411894702.9

(51) Int. Cl. H04N 23/52; G03B 17/12; H04N 23/51

(52) U.S. Cl. CPC H04N 23/52; G03B 17/12; H04N 23/51

(57) ABSTRACT

A lens device includes at least one lens, an annular body and a carrier. The annular body includes a main body and a microstructure. The carrier defines an accommodating space to contain the at least one lens and the annular body. The main body is configured to surround an axis and includes a first surface. The microstructure includes a plurality of protrusions protruding from the first surface. Each of the protrusions includes a first end, a second end disposed opposite to the first end in a direction parallel to the axis, a first end surface disposed at the first end and perpendicular to the axis, and a second end surface disposed at the second end and perpendicular to the axis. The first end surface and the second end surface have different geometric shapes.

### BACKGROUND OF THE INVENTION

### Field of the Invention

The invention relates to a technical field of elements of an optical lens, and more particularly to a lens device that has an annular body with microstructure formed thereon to avoid generation of stray light.

### Description of the Related Art

A conventional lens device generally includes a carrier and multiple lenses disposed in the carrier. Multiple mounting surfaces are formed in the carrier to mount the lenses. The lenses are positioned by a ring spacer disposed between each two adjacent lenses. Further, a pressure ring is provided in the carrier to hold the outermost lens. The surfaces of the pressure ring, the ring spacer and/or the carrier that are disposed near the lenses may reflect the light passing through the lens device to form stray light. If the stray light reaches the image sensor, it will affect the image quality of the lens device.

A conventional lens device may further include an adapter element for connecting the carrier and the image sensor. During operation, light passes through the lenses in the carrier and reaches the image sensor to form images. However, when the light passes through the adapter element, the adapter element may also reflect the light to form stray light that affects the image quality.

### BRIEF SUMMARY OF THE INVENTION

An object of the invention is to provide a lens device, particularly a lens device having lens-positioning elements for eliminating stray light. The invention can solve the conventional problem arising from the stray light, while the imaging effect on the image sensor is susceptible to the stray light which cannot be completely avoided in the prior art.

The lens device in accordance with an exemplary embodiment of the invention includes at least one lens, an annular body and a carrier. The annular body includes a main body and a microstructure. The carrier defines an accommodating space to contain the at least one lens and the annular body. The main body is configured to surround an axis and includes a first surface. The microstructure includes a plurality of protrusions protruding from the first surface. Each of the protrusions includes a first end, a second end disposed opposite to the first end in a direction parallel to the axis, a first end surface disposed at the first end and perpendicular to the axis, and a second end surface disposed at the second end and perpendicular to the axis. The first end surface and the second end surface have different geometric shapes.

In another exemplary embodiment, the first end surface includes a first bottom side and a first vertex. The first bottom side is disposed on the first surface and has a first width. The first vertex is distant from the first bottom side at a first height. The second end surface includes a second bottom side and a second vertex. The second bottom side is disposed on the first surface and has a second width. The second vertex is distant from the second bottom side at a second height. Each of the protrusions further includes a ridge extending from the first vertex to the second vertex.

In yet another exemplary embodiment, the ridge is a straight line or a curved line.

In another exemplary embodiment, the first width is equal to the second width, or the first width is not equal to the second width.

In yet another exemplary embodiment, the first height is greater than the second height, or the first height is less than the second height.

In another exemplary embodiment, the first end surface includes a first bottom side and a first vertex. The first bottom side is disposed on the first surface. The first vertex is distant from the first bottom side at a first height. The second end surface includes a second bottom side and a second vertex. The second bottom side is disposed on the first surface. Each of the protrusions further includes a ridge extending from the first vertex to the second vertex. The lens device satisfies one or more of the following conditions or any combination thereof: 0.06 mm≤L1≤0.3 mm, 1°<θ<10°, 3.3 degrees/mm<θ/L1<167 degrees/mm, and 0.9≤L1/H1≤7.2, where L1 is a first extending length measured from a midpoint of the first bottom side to that of the second bottom side, θ is an inclined angle formed between the ridge and the axis, and H1 is the first height.

In yet another exemplary embodiment, the protrusions include one protrusion and the adjacent protrusion thereof, the first height of the one protrusion is greater than that of the adjacent protrusion, and the first height of the one protrusion is equal to the second height of the adjacent protrusion. Each of the protrusions has a linear variation in width from the first width to the second width.

In another exemplary embodiment, the first end surface includes a first vertex. The lens device satisfies one or more of the following conditions or any combination thereof: 0.03 mm<d<0.1 mm, 20°<δ<75°, 560 degrees/mm<δ/d <2,500 degrees/mm, where d is a vertex pitch defined as a distance between the first vertexes of two adjacent protrusions and δ is a top angle of each protrusion at the first vertex thereof.

In yet another exemplary embodiment, the first height is greater than the second height, and the first width is greater than the second width; or the second height is greater than the first height, and the second width is greater than the first width.

In another exemplary embodiment, the first end surface is triangular or trapezoidal or polygonal, and the second end surface is triangular or trapezoidal or polygonal.

In yet another exemplary embodiment, the lens device includes at least one lens, an annular body and a carrier. The annular body includes a main body and a microstructure. The carrier defines an accommodating space to contain the at least one lens and the annular body. The main body includes an outer circumferential wall and an inner circumferential wall disposed opposite to the outer circumferential wall. The outer circumferential wall and the inner circumferential wall are configured to surround an axis. The inner circumferential wall includes a first surface and a second surface, which are respectively configured to form stepped structures. The microstructure is disposed on the first surface and the second surface, and includes a plurality of first protrusions protruding from the first surface and a plurality of second protrusions protruding from the second surface. The first and second protrusions are extended in a direction along the axis. Each of the first protrusions on the first surface has a first extending length measured L1 in the direction along the axis. Each of the second protrusions on the second surface has a second extending length L2 measured in the direction along the axis. The lens device satisfies one or more of the following conditions or any combination thereof: 0.06 mm≤L1≤0.3 mm, 0.06 mm≤L2≤0.3 mm, L1/L2>2.7, and L2/L1<0.35, where L1 is the first extending length and L2 is the second extending length.

In another exemplary embodiment, the lens device satisfies one or more of the following conditions or any combination thereof: 580<N1<860, 580<N2<860, and 1,930 mm⁻¹<N1/L1<14,400 mm⁻¹, where N1 is the number of the first protrusions protruding from the first surface, N2 is the number of the second protrusions protruding from the second surface, and L1 is the first extending length in unit of mm.

In yet another exemplary embodiment, the lens device includes at least one lens, an annular body, a carrier, an image sensor and an adapter element. The carrier defines an accommodating space to contain the at least one lens and the annular body. The adapter element is configured to connect the carrier and the image sensor. The adapter element includes a mounting hole to mount the image sensor, a plurality of inner walls formed in the mounting hole, and a plurality of microstructures formed on at least one of the inner walls.

In another exemplary embodiment, the adapter element further includes a stepped hole connected to the mounting hole. The stepped hole is larger than the mounting hole to form stepped surfaces therebetween. The stepped hole is disposed closer to the at least one lens than the mounting hole. The adapter element has an axis which is configured to pass through the mounting hole. The axis is inclined with respect to the inner walls of the mounting hole at an included angle ranged from 0° to 45°.

In yet another exemplary embodiment, the microstructures are zigzag shaped structures which are spaced and arranged along the inner walls. The zigzag shaped structures include an end close to the stepped hole and another end distant from the stepped hole. The zigzag shaped structures are triangular, trapezoidal, or polygonal in cross section.

In another exemplary embodiment, each of the zigzag shaped structures is triangular in cross section and includes two sides, the two sides has an included angle therebetween, and the included angle is ranged from 20° to 75°. Two adjacent zigzag shaped structures are spaced a distance that is ranged from 0.03 mm to 0.1 mm.

The annular body of the lens device of the invention is provided with microstructure on the inner circumferential wall. The microstructure includes a plurality of protrusions. Each protrusion is extended in the direction parallel to the axis to form a raised rib. For each protrusion, the first end surface of the first end and the second end surface of the second end have different geometric shapes. Therefore, the protrusions of the microstructure can be inclined and arranged in a zigzag form, can be arranged alternately and in a zigzag form, and can be triangular pyramidal and extended transversely. The protrusions are extended in a direction parallel to the axis so that the light reflected by the protrusions can travel away from the image sensor disposed at an end of the lens device. Therefore, poor quality images (e.g. flare or overlapping images) arising from stray light can be avoided.

Further, the annular body of the invention has microstructure formed on the first and second surfaces which are arranged in a stepped manner and on the inner circumferential wall. The microstructure on the first surface and the second surface is configured to reflect the stray light twice so that propagation of the stray light is more away from the image sensor. It can more effectively prevent the stray light from affecting the imaging effect on the image sensor.

### BRIEF DESCRIPTION OF THE DRAWINGS

FIG. 1 depicts a cross section of a lens device of the invention.

FIG. 2 is a perspective view of an annular body in accordance with a first embodiment of the invention.

FIG. 3 is a partial enlarged view of the annular body of FIG. 2.

FIG. 4 is a sectional view of the annular body of FIG. 2.

FIG. 5 is a partial perspective view of the annular body in accordance with a second embodiment of the invention.

FIG. 6 is another partial perspective view of the annular body of FIG. 5, observed at a different angle.

FIG. 7 is a sectional view of the annular body of FIG. 5.

FIG. 8 is a partial perspective view of the annular body in accordance with a third embodiment of the invention.

FIG. 9 is another partial perspective view of the annular body of FIG. 8, observed at a different angle.

FIG. 10 is a sectional view of the annular body of FIG. 8.

FIG. 11 is a partial perspective view of the annular body in accordance with a fourth embodiment of the invention.

FIG. 12 is a partial enlarged view of the annular body of FIG. 11.

FIG. 13 is a partial perspective view of the annular body in accordance with a fifth embodiment of the invention.

FIG. 14 is a schematic view showing an adapter element in accordance with an embodiment of the invention.

FIG. 15 is a partial enlarged view of the adapter element of FIG. 14.

FIG. 16 is a sectional view of the adapter element of FIG. 14.

### DETAILED DESCRIPTION OF THE INVENTION

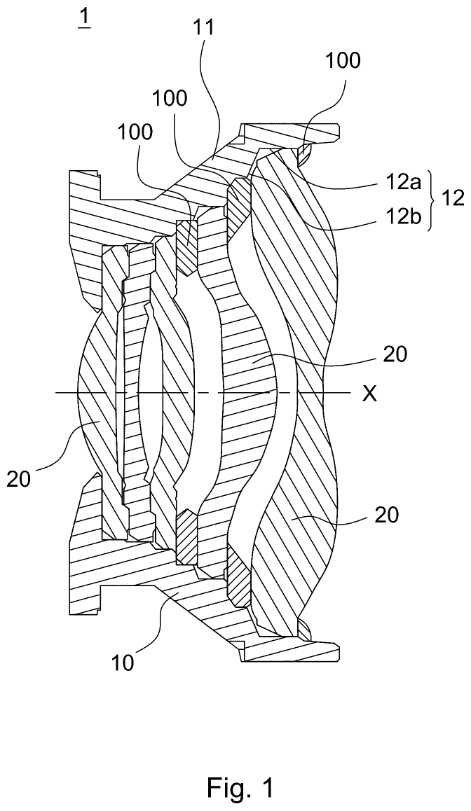

FIG. 1 depicts a lens structure of a lens device of the invention, wherein the lens structure 1 includes a carrier 10, at least one lens 20, at least one annular body 100 and an image sensor (not shown). The carrier 10 has an accommodating space to contain the at least one lens 20 and the at least one annular body 100. The annular body 100 may be a spacer ring, a pressure ring or an annular structure of the carrier 10. However, the invention is not limited thereto. Light coming from an object at the object side passes through the lenses 20 and the annular body 100 and reaches the image sensor which is disposed closer to the image side than the lenses 20 and the annular body 100. The carrier 10 is cylindrical, including an outer circumferential surface 11 and an inner circumferential surface 12. The outer circumferential surface 11 and the inner circumferential surface 12 are disposed to surround an axis X. The inner circumferential surface 12 has multiple mounting surfaces 12a and connecting surfaces 12b arranged in a stepped manner. The mounting surfaces 12a are configure to mount at least one lens 20. Two adjacent lenses 20 which are spaced a comparatively large distance apart may have one annular body 100 disposed therebetween, thereby being kept in place in the carrier 10. Also, an annular body 100 may be disposed at a side of the lens that is closest to the image side, thereby keeping the lens that is closest to the image side in place in the carrier 10. The optical axis of the lenses 20 is configured to coincide with the axis X.

Both of the carrier 10 and the annular body 100 have surfaces disposed toward the lenses 20 and the surfaces may reflect light to generate stray light that affects the image quality. Therefore, a positioning element of the invention for eliminating stray light is applicable to the annular body 100. The annular body 100 is disposed between the object side and the lens 20 closest to the object side, between the lenses 20, or between the image sensor and the lens 20 closest to the image sensor.

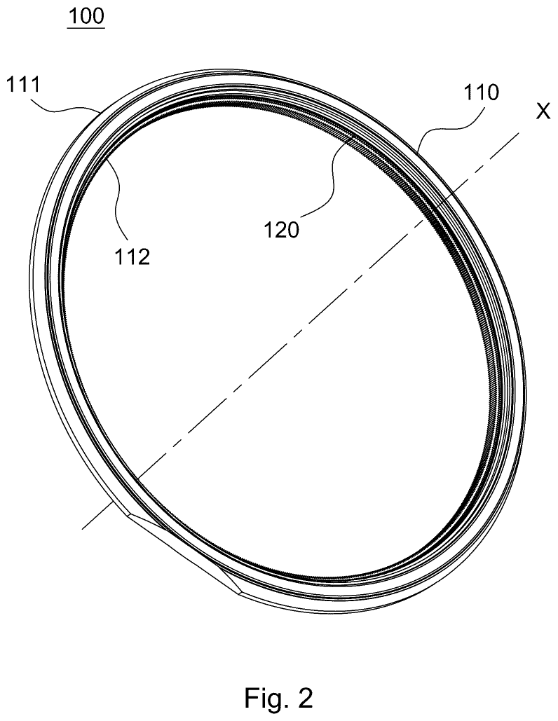

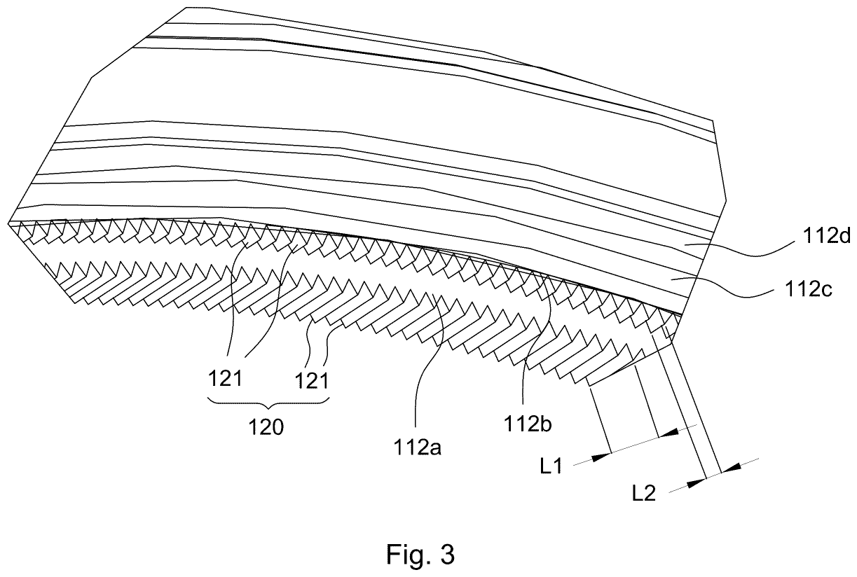

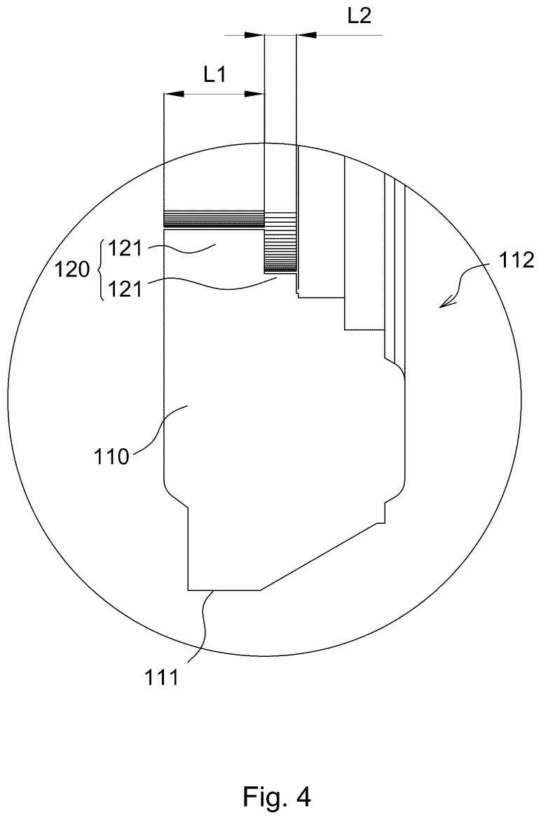

Referring to FIGS. 2, 3 and 4, an annular body of a lens device in accordance with a first embodiment of the invention includes a main body 110 and a microstructure 120. The main body 110 is ring-shaped or cylindrical. As shown, the main body 110 includes an outer circumferential wall 111 and an inner circumferential wall 112. The outer circumferential wall 111 and the inner circumferential wall 112 are disposed to surround the axis X. The inner circumferential wall 112 has multiple surfaces 112a, 112b, 112c, 112d. The surfaces 112a, 112b, 112c, 112d, each of which is annular, are arranged in a stepped manner and along the axis X. Among the surfaces 112a, 112b, 112c, 112d, the first surface 112a and the second surface 112b have the microstructure formed thereon. The first surface 112a is disposed closer to the lenses 20 than the second surface 112b. Alternatively, the first surface 112a is disposed close to the object side (not shown) while the second surface 112b is disposed close to the image side (not shown). However, the invention is not limited thereto. For example, the microstructure 120 may be formed on at least two of the surfaces 112a, 112b, 112c, 112d.

The microstructure 120 includes a plurality of protrusions 121. In the first embodiment, each protrusion 121 is a raised rib. The protrusion 121 is extended along the axis X. The two ends of the protrusion 121 on the first surface 112a are respectively flushed with the two ends of the first surface 112a, and the two ends of the protrusion 121 on the second surface 112b are respectively flushed with the two ends of the second surface 112b. Therefore, each of the protrusions 121 of the first embodiment is extended in a direction parallel to the axis X. Further, the protrusions 121 of the first embodiment are circumferentially arranged on the first surface 112a and the second surface 112b and with respect to the axis X. The cross section of each protrusion 121 is triangular. However, the invention is not limited thereto. In some other embodiments, the cross section of each protrusion 121 may be trapezoidal or in other shapes.

The protrusion 121 on the first surface 112a has a first extending length L1 measured along the axis X, and the protrusion 121 on the second surface 112b has a second extending length L2 measured along the axis X. The first extending length L1 is ranged from 0.06 mm to 0.3 mm, namely 0.06 mm≤L1≤0.3 mm. The second extending length L2 is ranged from 0.06 mm to 0.3 mm, namely 0.06 mm≤L2≤0.3 mm. The ratio of the first extending length to the second extending length is greater than 2.7, namely L1/L2>2.7. The ratio of the second extending length to the first extending length is less than 0.35, namely L2/L1<0.35. In the first embodiment, the first extending length L1 is 0.258 mm and the second extending length L2 is 0.084 mm, or the first extending length L1 is 0.265 mm and the second extending length L2 is 0.087 mm, or the first extending length L1 is 0.087 mm and the second extending length L2 is 0.258 mm, or the first extending length L1 is 0.084 mm and the second extending length L2 is 0.265 mm. In other words, the lens device satisfies one or more of the following conditions or any combination thereof: 0.06 mm≤L1≤0.3 mm, 0.06 mm≤L2≤0.3 mm, L1/L2>2.7, and L2/L1<0.35. When one or more of the above conditions or any combination thereof is satisfied, the stray light and ghost images in the lens device can be effectively blocked and the undesired light can be prevented from reaching the image sensor. Therefore, the ghost images and stray light of the lens device can be significantly avoided.

The first surface 112a has N1 protrusions 121 provided thereon. The second surface 112b has N2 protrusions provided thereon. On the first surface 112a or the second surface 112b, the number of the protrusions 121 is related to the width of the protrusions 121. The protrusions 121 are arranged into a 360-degree structure. Therefore, the larger the width of the protrusions 121, the smaller the number of the protrusions 121. The smaller the width of the protrusions 121, the greater the number of the protrusions 121. The number N1 of the protrusions 121 on the first surface 112a is ranged between 580 and 860, namely 580<N1<860. The number N2 of the protrusions 121 on the second surface 112a is also ranged between 580 and 860, namely 580<N2<860. The ratio of the number N1 of the protrusions 121 on the first surface 112a to the first extending length L1 is between 1,930 mm⁻¹ and 14,400 mm⁻¹, namely 1,930 mm⁻¹<N1/L1<14,400 mm⁻¹. In the first embodiment, seven hundred and twenty protrusions 121 are provided on the first surface 112a, and seven hundred and twenty protrusions 121 are provided on the second surface 112b. However, the invention is not limited thereto. The number N1 may be greater than the number N2. Alternatively, the number N1 may be smaller than the number N2. In other words, the lens device satisfies one or more of the following conditions or any combination thereof: 580<N1<860, 580<N2<860, and 1,930 mm⁻¹<N1/L1<14,400 mm⁻¹. When one or more of the above conditions or any combination thereof is satisfied, the manufacturing yield can be promoted and the manufacturing cost can be reduced. The problems of the ghost images and stray light of the lens device can be solved under the condition that the lens device is effectively manufactured. The image quality of the lens device is good.

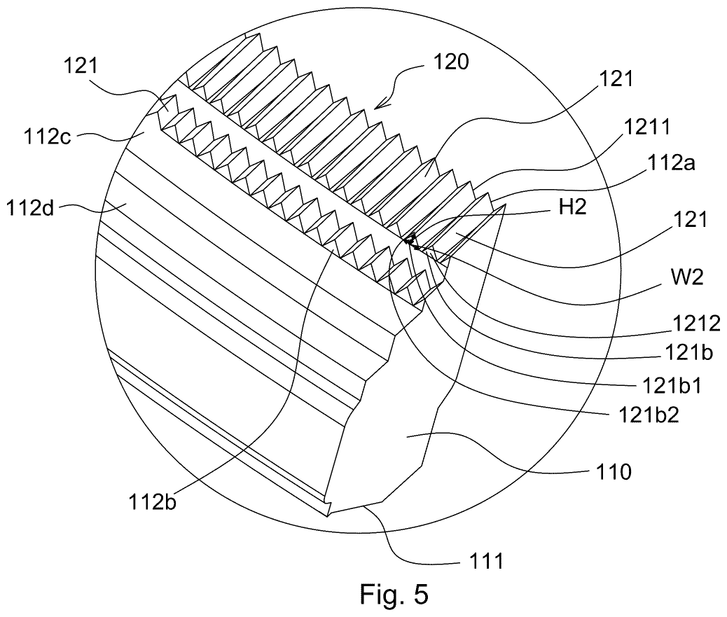

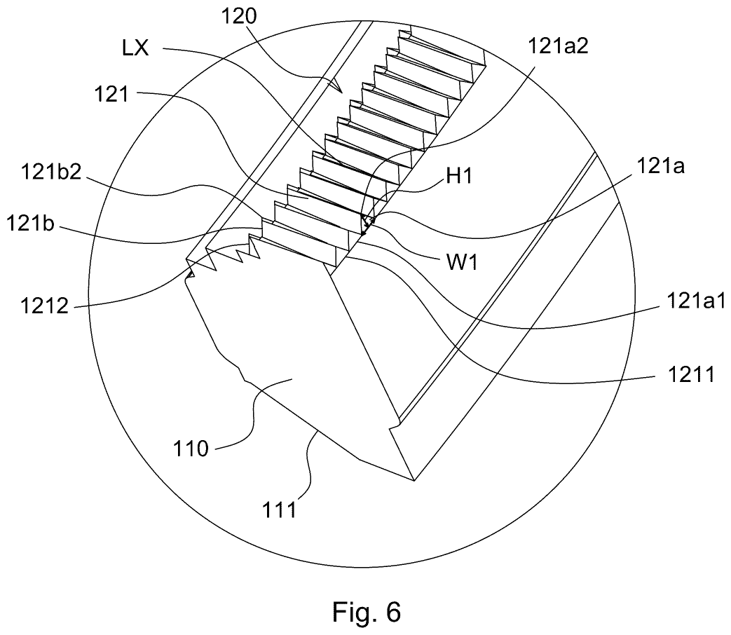

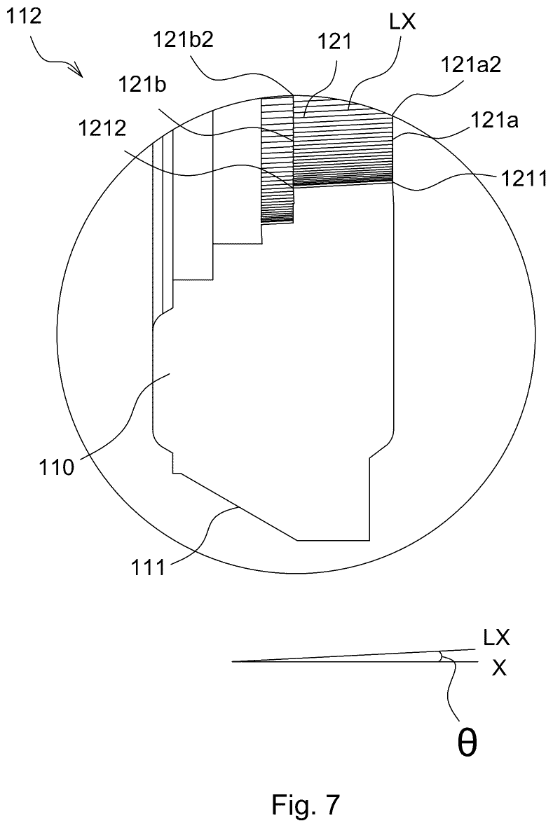

FIGS. 5, 6 and 7 depict an annular body in accordance with the second embodiment of the invention. The annular body of the second embodiment has the same structure as that of the first embodiment, so the same parts are represented by the same symbols and the descriptions thereof are omitted. In the second embodiment, the protrusion 121 disposed on the first surface 112a has a first end 1211 and a second end 1212, wherein the second end 1212 is disposed opposite to the first end 1211 in the direction parallel to the axis X. The first end is distant from the second surface 112b and the second end is close to the second surface 112b. In the second embodiment, the first end 1211 and the second end 1212 are respectively flushed with the two ends of the first surface 112a. The protrusion 121 further has a first end surface 121a at the first end 1211 that is perpendicular to the axis X, and a second end surface 121b at the second end 1212 that is also perpendicular to the axis X. In the second embodiment, the first end surface 121a and the second end surface 121b are triangular wherein the second end surface 121b is smaller than the first end surface 121a in dimensions. In some other embodiments, the first end surface and the second end surface may be trapezoidal or in other shapes.

The first end surface 121a has a first bottom side 121a1 and a first vertex 121a2. The first bottom side 121a1 having a first width W1 is disposed on the inner circumferential wall 112. The first vertex 121a2 is distant from the first bottom side 121a1 at a first height H1. The second end surface 121b has a second bottom side 121b1 and a second vertex 121b2. The second bottom side 121b1 having a second width W2 is also disposed on the inner circumferential wall 112. The second vertex 121b2 is distant from the second bottom side 121b1 at a second height H2. In the second embodiment, the first height H1 is greater than the second height H2. The first height H1 is ranged from 0.04 mm to 0.7 mm. The second height H2 is ranged from 0.04 mm to 0.6 mm. For example, the first height H1 is 0.624 mm and the second height H2 is 0.0416 mm. In other words, the heights of the end surfaces of the protrusion 121 when measured in a direction parallel to the axis X are in the range of 0.052 mm±20% and the first height H1 is greater than the second height H2. The protrusion 121 further has a ridge LX extending from the first vertex 121a2 to the second vertex 121b2. In the second embodiment, the ridge Lx is a straight line. However, the invention is not limited thereto. In some other embodiments, the ridge LX extending from the first vertex 121a2 to the second vertex 121b2 may be a curved line. An inclined angle θ is formed between the ridge LX and the axis X. The inclined angle θ satisfies one degree<θ<ten degrees. The first extending length L1 (extending length L) mentioned above is defined as the distance from the midpoint of the first bottom side 121a1 to the midpoint of the second bottom side 121b1. In the second embodiment, the first extending length L1 is ranged from 0.06 mm to 0.3 mm, namely 0.06 mm≤L1≤0.3 mm. For example, the first extending length L1 is 0.25 mm. The ratio of the inclined angle θ to the first extending length L1 satisfies 3.3 degrees/mm<θ/L1<167 degrees/mm. The ratio of the first extending length L1 to the first height H1 satisfies 0.9≤L1/H1≤7.2. In the second embodiment, the first width W1 is equal to the second width W2. However, the invention is not limited thereto. The first width W1 may be not equal to the second width W2. For example, the first width W1 is greater than the second width W2. Alternatively, the first width W1 is less than the second width W2. In other words, the lens device satisfies one or more of the following conditions or any combination thereof: 0.06 mm≤L1≤0.3 mm, 1°<θ<10°, 3.3 degrees/mm<θ/L1<167 degrees/mm, and 0.9≤L1/H1≤7.2. When one or more of the above conditions or any combination thereof is satisfied, the ghost images and stray light can be well blocked in the lens device and the image quality of the lens device is good.

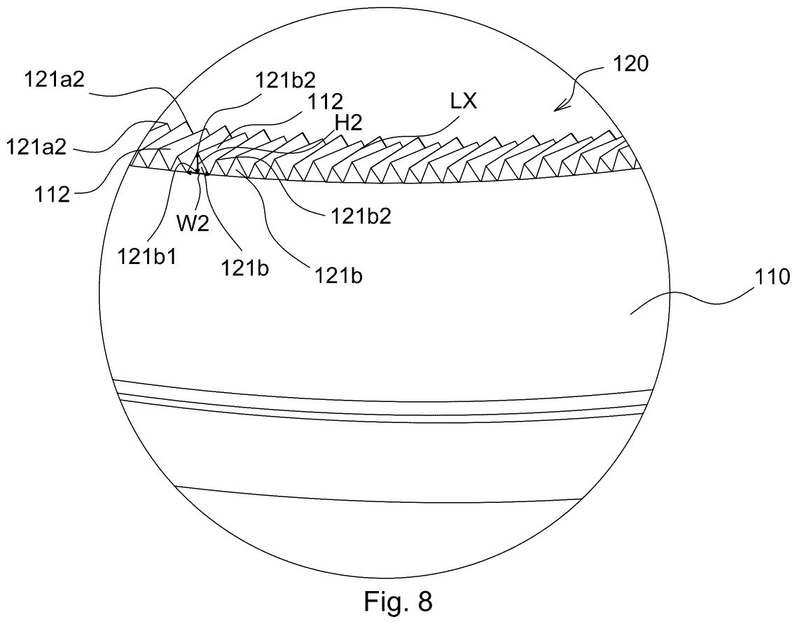

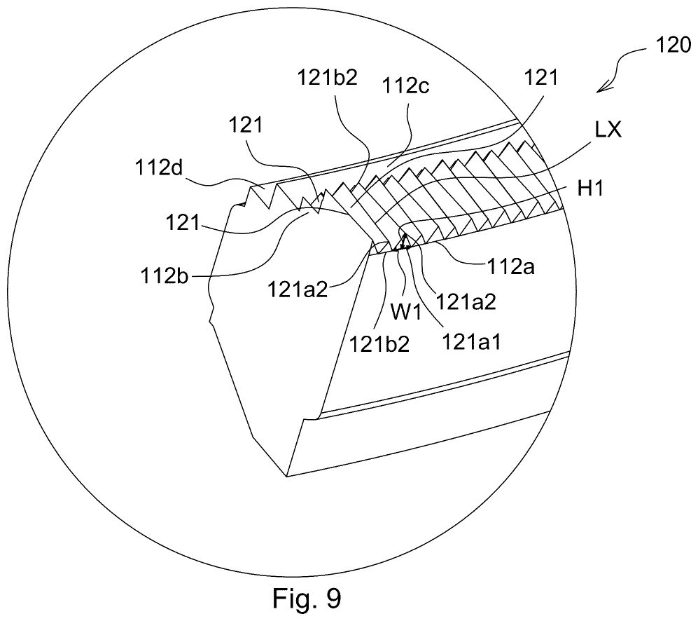

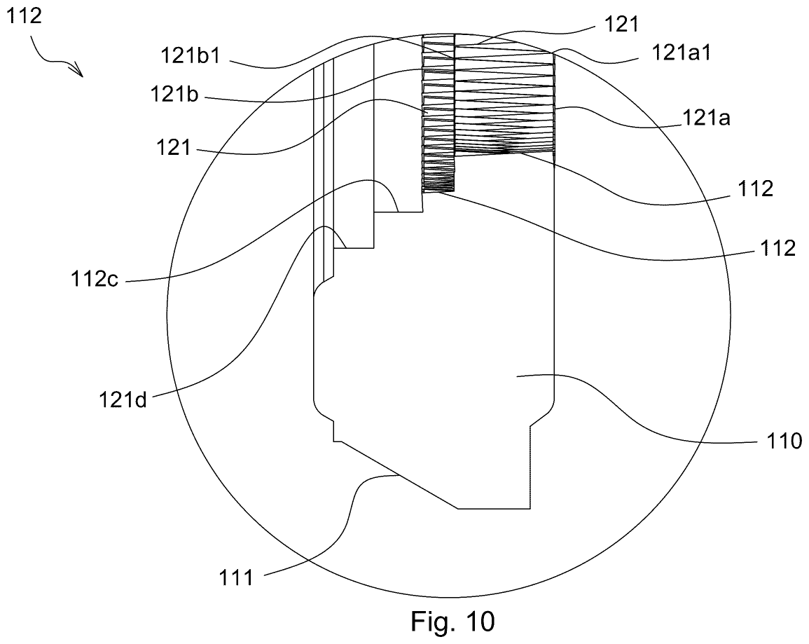

FIGS. 8, 9 and 10 depict an annular body in accordance with the third embodiment of the invention. The annular body of the third embodiment has the same structure as that of the second embodiment, so the same parts are represented by the same symbols and the descriptions thereof are omitted. In the third embodiment, a protrusion 121 and the adjacent protrusion 121 thereof are inclined in opposite directions, wherein the first height H1 of the protrusion 121 is greater than that of the adjacent protrusion 121, the second height H2 of the protrusion 121 is less than that of the adjacent protrusion 121, and the first height H1 of the protrusion 121 is equal to the second height H2 of the adjacent protrusion 121. However, the invention is not limited thereto. In another embodiment, the first height H1 of the protrusion 121 may be different from the second height H2 of the adjacent protrusion 121. In yet another embodiment, a plurality of protrusions 121 with the same inclination direction are provided at fixed intervals, and one or more protrusions 121 with opposite inclination directions are provided therebetween. In still yet another embodiment, a plurality of protrusions 121 with the same inclination direction are provided at arbitrary intervals, and one or more protrusions 121 with opposite inclination directions are provided therebetween. The lens device of the third embodiment, similar to that of the second embodiment, satisfies one or more of the following conditions or any combination thereof: 1°<θ<10°, 0.06 mm≤L1≤0.3 mm, 3.3 degrees/mm<θ/L1<167 degrees/mm, and 0.9≤L1/H1≤7.2 where θ is the inclined angle, L1 is the first extending length, and H1 is the first height.

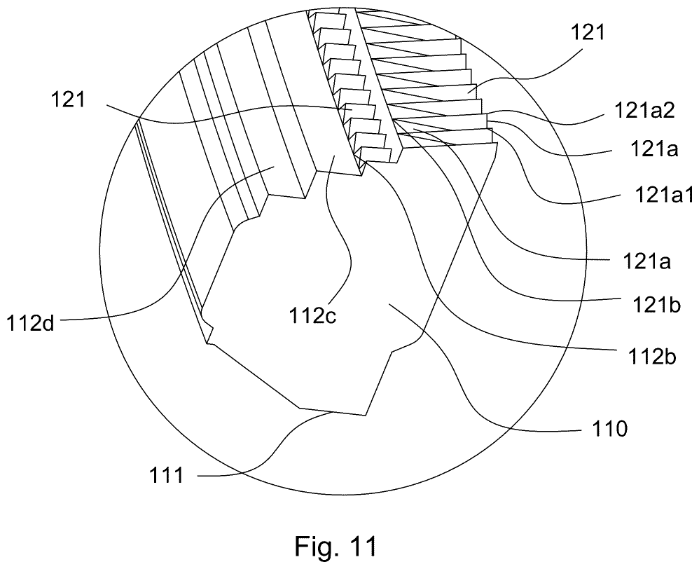

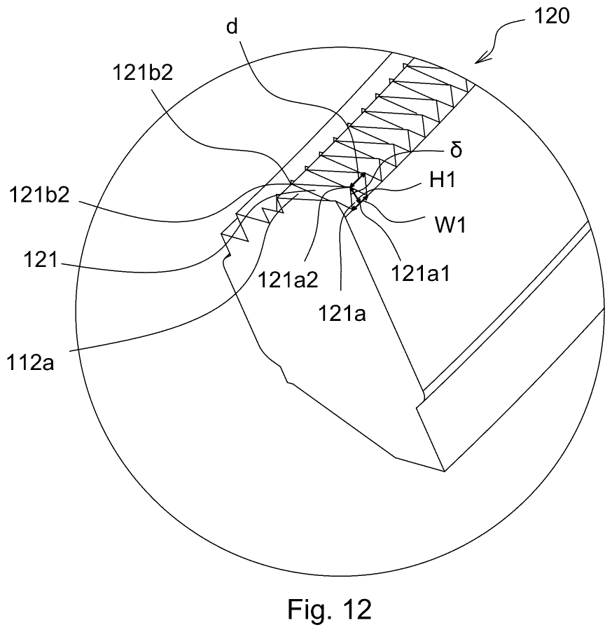

FIGS. 11 and 12 depict an annular body in accordance with the fourth embodiment of the invention. The annular body of the fourth embodiment has the same structure as that of the second embodiment, so the same parts are represented by the same symbols and the descriptions thereof are omitted. In the fourth embodiment, the first width W1 of the protrusion 121 is greater than the second width W2 and the second width W2 is zero. That is, the protrusion 121 of the fourth embodiment has a triangular pyramidal shape. A vertex pitch d is defined as the distance between the first vertexes 121a2 of two adjacent protrusions 121 and 0.03 mm<d<0.1 mm. Each protrusion 121 has a top angle δ at the first vertex 121a2 and 20°<δ<75°. The ratio of the top angle δ to the vertex pitch d satisfies 560 degrees/mm<δ/d<2500 degrees/mm. In other words, the lens device satisfies one or more of the following conditions or any combination thereof: 0.03 mm<d<0.1 mm, 20°<δ<75°, and 560 degrees/mm<δ/d<2500 degrees/mm. When one or more of the above conditions or any combination thereof is satisfied, the problem of the ghost images and stray light of the lens device can be solved and the image quality of the lens device is good.

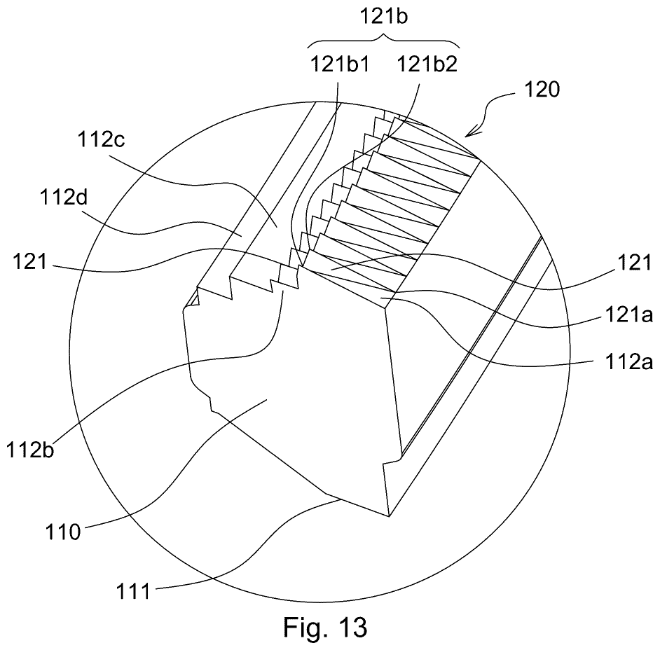

FIG. 13 depicts an annular body in accordance with the fifth embodiment of the invention. The annular body of the fifth embodiment has the same structure as that of the fourth embodiment, so the same parts are represented by the same symbols and the descriptions thereof are omitted. In the fifth embodiment, the second height H2 of the protrusion 121 is greater than the first height H1, the second width W2 is greater than the first width W1, and the first width W1 is zero. That is, the protrusion 121 of the fifth embodiment has a triangular pyramidal shape. The protrusions 121 of the fifth embodiment and the fourth embodiment are inclined in opposite directions. A vertex pitch d is defined as the distance between the second vertexes 121b2 of two adjacent protrusions 121 and 0.03 mm<d<0.1 mm. Each protrusion 121 has a top angle δ at the second vertex 121b2 and 20°<δ<75°. The ratio of the top angle δ to the vertex pitch d satisfies 560 degrees/mm<δ/d<2,500 degrees/mm. In other words, the lens device satisfies one or more of the following conditions or any combination thereof: 0.03 mm<d<0.1 mm, 20°<δ<75°, and 560 degrees/mm<δ/d<2,500 degrees/mm. When one or more of the above conditions or any combination thereof is satisfied, the problem of the ghost images and stray light of the lens device can be solved and the image quality of the lens device is good.

The annular body of the invention is provided with microstructure on the inner circumferential wall. The microstructure includes a plurality of protrusions. Each protrusion 121 is extended in the direction parallel to the axis to form a raised rib. For each protrusion 121, the first end surface of the first end and the second end surface of the second end have different geometric shapes. Therefore, the protrusions of the microstructure can be inclined and arranged in a zigzag form, can be arranged alternately and in a zigzag form, and can be triangular pyramidal. The protrusions are extended in a direction parallel to the axis so that the light reflected by the protrusions can travel away from the image sensor disposed at an end of the lens device. Therefore, poor quality images (e.g. flare or overlapping images) arising from stray light can be avoided.

Further, the annular body of the invention has microstructure formed on the first and second surfaces which are arranged in a stepped manner and on the inner circumferential wall. The microstructure on the first surface and the second surface is configured to reflect the stray light twice so that the propagation of the stray light is more away from the image sensor. It can more effectively prevent the stray light from affecting the imaging effect on the image sensor. However, the invention is not limited thereto. The stepped structure can be provided on more than two surfaces of the inner circumferential wall. The configuration of the microstructure can be modified according to the requirements and the optical characteristics of the lens group, if the modification of the configuration of the microstructure on the inner circumferential wall is not structurally limited. For example, the microstructure can be provided one surface or three surfaces.

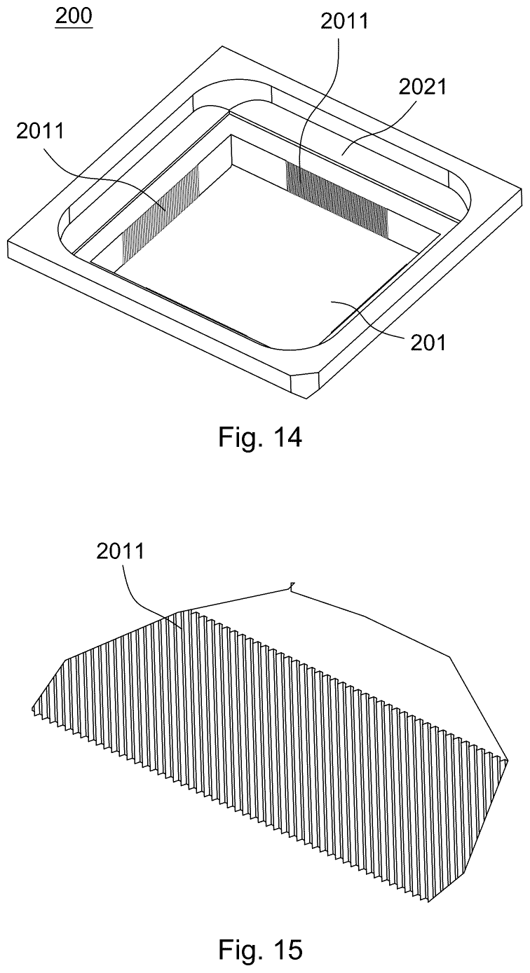

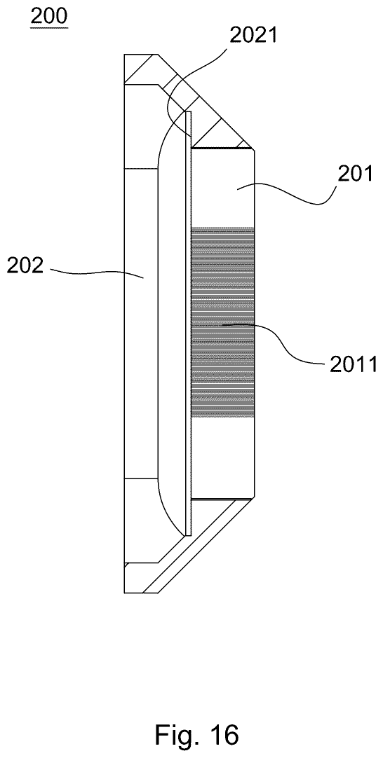

The lens device of the invention may further include an adapter element for connecting the carrier 10 and the image sensor (not shown). FIG. 14 is a schematic view of the adapter element 200 in accordance with an embodiment of the invention. FIG. 15 is a partial enlarged view of the adapter element 200 of FIG. 14. FIG. 16 is a sectional view of the adapter element 200 of FIG. 14. The adapter element 200 is configured to mount the image sensor and connected to the carrier 10. In operation, light passes through the lenses 20 in the carrier 10 and reaches the image sensor to form images.

The adapter element 200 has a closed shape to form a mounting hole 201. The image sensor is installed in the mounting hole 201. The mounting hole 201 has an axis that coincides with the optical axis of the lenses 20. The section of the outer circumferential wall of the adapter element 200 may be symmetrical in shape and non-circular. For example, the adapter element 200 is rectangular as shown in FIG. 14. However, the invention is not limited thereto. The adapter element 200 may be circular or in any other shape that is easy to mount the image sensor.

The adapter element 200 further has a stepped hole 202 formed therein. The stepped hole 202 is connected to the mounting hole 201. The stepped hole 202 is larger than the mounting hole 201 to form stepped surfaces 2021 therebetween. The stepped hole 202 is closer to the lenses 20 than the mounting hole 201. The stepped surfaces 2021 facilitate the image sensor to be positioned.

Preferably, the axis of the mounting hole 201 is inclined with respect to the inner walls of the mounting hole 201 at an included angle β and 0°≤β≤45°. Therefore, the inner walls of the mounting hole 201 and the incident light travelling along the axis of mounting hole 201 have an included angle which is ranged from 0° to 45°. Multiple microstructures are formed on the inner walls of the mounting hole 201. The microstructures may be zigzag shaped structures 2011. Specifically, the inner walls of the mounting hole 201 has multiple zigzag shaped structures 2011 which are spaced and arranged along the inner walls. Each zigzag structure 2011 has an end close to the stepped hole 202 and another end distant from the stepped hole 202.

The zigzag shaped structure 2011 may be provided on one or more inner walls. The cross section of the zigzag shaped structure may be triangular, trapezoidal, or polygonal. Preferably, the cross section of the zigzag shaped structure 2011 is triangular and two sides of the triangle have an included angle ranged from 20° to 75°. Two adjacent zigzag shaped structures 2011 are spaced a distance that is ranged from 0.03 mm to 0.1 mm.

During the process that the incident light enters the lens device and reaches the image sensor, the stray light, reflected by the zigzag shaped structures 2011 on the inner walls of the mounting hole 201, is away from the image sensor. It can more effectively prevent the stray light from affecting the imaging effect on the image sensor.

The microstructures mentioned in above embodiments are provided on the annular body 100 of the lens device or on the adapter element 200 of the lens device that connects the carrier 10 and the image sensor (not shown). However, the invention is not limited thereto. To effectively solve the problems of the stray light, the microstructures can be provided in various ways. For example, the microstructures are only provided on the annular body 100 when the lens device includes the annular body 100 and the adapter element 200. For another example, the microstructures are provided on the annular body 100 when the lens device includes the annular body 100 but does not include the adapter element 200. For another example, the microstructures are only provided on the adapter element 200 when the lens device includes the annular body 100 and the adapter element 200 and there is no stray light on the annular body 100. For another example, the microstructures are provided on the adapter element 200 when the lens device includes the adapter element 200 but does not include the annular body 100. It is understood that in the invention the microstructures can be provided on only the annular body 100, only the adapter element 200, or both of the annular body 100 and the adapter element 200. In brief, the invention provides microstructures at the locations where the undesired light is generated, in particular on the annular body that is generally used in the lens device to support the lenses, and on the adapter element that connects the carrier and the image sensor. All can effectively prevent the stray light from affecting the imaging effect on the image sensor, and all are the invention or belong to the category of the invention.

What is described above is only the preferred embodiment of the invention, and the scope of the invention is not limited thereto. That is, the simple equivalent changes and modifications made according to the description of the invention and the claims are all within the scope of the invention. Further, any one of the embodiments or claims is not required to achieve all the objects or advantages or features of the invention. Further, the abstract and title are only used to assist in the search of patent documents and are not intended to limit the scope of the invention. Further, the terms “first” and “second” described in the specification and claims are only used to distinguish between different elements, embodiments or scopes, without limiting the quantity of the elements with an upper limit or a lower limit.

What is claimed is:

1. A lens device, comprising:
at least one lens;
an annular body comprising a main body and a microstructure;
a carrier defining an accommodating space to contain the at least one lens and the annular body;
wherein the main body is configured to surround an axis and comprises a first surface;
wherein the microstructure comprises a plurality of protrusions protruding from the first surface;
wherein each of the protrusions comprises a first end, a second end disposed opposite to the first end in a direction along the axis, a first end surface disposed at the first end and perpendicular to the axis, and a second end surface disposed at the second end and perpendicular to the axis;
wherein the first end surface and the second end surface have different geometric shapes.

2. The lens device as claimed in claim 1, wherein:
the first end surface comprises a first bottom side and a first vertex;
the first bottom side is disposed on the first surface and has a first width;
the first vertex is distant from the first bottom side at a first height;
the second end surface comprises a second bottom side and a second vertex;
the second bottom side is disposed on the first surface and has a second width;
the second vertex is distant from the second bottom side at a second height;
each of the protrusions further comprises a ridge extending from the first vertex to the second vertex.

3. The lens device as claimed in claim 2, wherein the ridge is a straight line or a curved line.

4. The lens device as claimed in claim 2, wherein the first width is equal to the second width, or the first width is not equal to the second width.

5. The lens device as claimed in claim 2, wherein the first height is greater than the second height, or the first height is less than the second height.

6. The lens device as claimed in claim 2, wherein the lens device satisfies one or more of the following conditions or any combination thereof:
$$0.06 mm ≦ L 1 ≦ 0.3 mm ,$$
$$1 ° < θ < 10 ° ,$$
$$3.3 degrees / mm < θ / L 1 < 167 degree / mm , and$$
$$0.9 ≦ L 1 / H 1 ≦ 7.2 ,$$
where L1 is a first extending length measured from a midpoint of the first bottom side to that of the second bottom side, θ is an inclined angle formed between the ridge and the axis, and H1 is the first height.

7. The lens device as claimed in claim 1, wherein:
the first end surface comprises a first bottom side and a first vertex, the first bottom side is disposed on the first surface, and the first vertex is distant from the first bottom side at a first height;
the second end surface comprises a second bottom side and a second vertex, and the second bottom side is disposed on the first surface;
each of the protrusions further comprises a ridge extending from the first vertex to the second vertex;
the lens device satisfies one or more of the following conditions or any combination thereof:
$$0.06 mm ≦ L 1 ≦ 0.3 mm ,$$
$$1 ° < θ < 10 ° ,$$
$$3.3 degrees / mm < θ / L 1 < 167 degree / mm , and$$
$$0.9 ≦ L 1 / H 1 ≦ 7.2 ,$$
where L1 is a first extending length measured from a midpoint of the first bottom side to that of the second bottom side, θ is an inclined angle formed between the ridge and the axis, and H1 is the first height.

8. The lens device as claimed in claim 2, wherein:
the protrusions comprise one protrusion and the adjacent protrusion thereof, the first height of the one protrusion is greater than that of the adjacent protrusion, and the first height of the one protrusion is equal to the second height of the adjacent protrusion;
each of the protrusions has a linear variation in width from the first width to the second width.

9. The lens device as claimed in claim 2, wherein the lens device satisfies one or more of the following conditions or any combination thereof:
$$0.03 mm < d < 0.1 mm ,$$
$$20 ° < δ < 75 ° ,$$
$$560 degrees / mm < δ / d < 2 , 500 degrees / mm ,$$
where d is a vertex pitch defined as a distance between the first vertexes of two adjacent protrusions and δ is a top angle of each protrusion at the first vertex thereof.

10. The lens device as claimed in claim 1, wherein:
the first end surface comprises a first vertex,
the lens device satisfies one or more of the following conditions or any combination thereof:
$$0.03 mm < d < 0.1 mm ,$$
$$20 ° < δ < 75 ° ,$$
$$560 degrees / mm < δ / d < 2 , 500 degrees / mm ,$$
where d is a vertex pitch defined as a distance between the first vertexes of two adjacent protrusions and δ is a top angle of each protrusion at the first vertex thereof.

11. The lens device as claimed in claim 9, wherein the first height is greater than the second height, and the first width is greater than the second width; or the second height is greater than the first height, and the second width is greater than the first width.

12. The lens device as claimed in claim 1, wherein the first end surface is triangular or trapezoidal or polygonal, and the second end surface is triangular or trapezoidal or polygonal.

13. A lens device, comprising:
at least one lens;
an annular body comprising a main body and a microstructure;
a carrier defining an accommodating space to contain the at least one lens and the annular body;
wherein the main body comprises an outer circumferential wall and an inner circumferential wall disposed opposite to the outer circumferential wall;
wherein the outer circumferential wall and the inner circumferential wall are configured to surround an axis;
wherein the inner circumferential wall comprises a first surface and a second surface, which are respectively configured to form stepped structures;
wherein the microstructure is disposed on the first surface and the second surface, and comprises a plurality of first protrusions protruding from the first surface and a plurality of second protrusions protruding from the second surface;
wherein the first and second protrusions are extended in a direction along the axis;
wherein each of the first protrusions on the first surface has a first extending length measured L1 in the direction along the axis;
wherein each of the second protrusions on the second surface has a second extending length L2 measured in the direction along the axis;
wherein the lens device satisfies one or more of the following conditions or any combination thereof:
$$0.06 mm ≦ L 1 ≦ 0.3 mm ,$$
$$0.06 mm ≦ L 2 \underline{\leq } 0.3 mm ,$$
$$L 1 / L 2 > 2.7 , and$$
$$L 2 / L 1 < 0.35 ,$$
where L1 is the first extending length and L2 is the second extending length.

14. The lens device as claimed in claim 13, wherein the lens device satisfies one or more of the following conditions or any combination thereof:
$$580 < N 1 < 8 \; 60 ,$$
$$580 < N 2 < 860 , and$$
$$1 , 930 {mm}^{- 1} < N 1 / L 1 < 14 , 400 {mm}^{- 1} ,$$
where N1 is the number of the first protrusions protruding from the first surface, N2 is the number of the second protrusions protruding from the second surface, and L1 is the first extending length in unit of mm.

15. A lens device comprising:
at least one lens;
an annular body;
a carrier defining an accommodating space to contain the at least one lens and the annular body;
an image sensor; and
an adapter element configured to connect the carrier and the image sensor;
wherein the adapter element comprises a mounting hole to mount the image sensor, a plurality of inner walls formed in the mounting hole, and a plurality of microstructures formed on at least one of the inner walls.

16. The lens device as claimed in claim 15, wherein:
the adapter element further comprises a stepped hole connected to the mounting hole;
the stepped hole is larger than the mounting hole to form stepped surfaces therebetween;
the stepped hole is disposed closer to the at least one lens than the mounting hole;
the adapter element has an axis which is configured to pass through the mounting hole;
the axis is inclined with respect to the inner walls of the mounting hole at an included angle ranged from 0° to 45°.

17. The lens device as claimed in claim 16, wherein:
the microstructures are zigzag shaped structures which are spaced and arranged along the inner walls;
the zigzag shaped structures comprise an end close to the stepped hole and another end distant from the stepped hole;
the zigzag shaped structures are triangular, trapezoidal, or polygonal in cross section.

18. The lens device as claimed in claim 17, wherein:
each of the zigzag shaped structures is triangular in cross section and comprises two sides, the two sides has an included angle therebetween, and the included angle is ranged from 20° to 75°;
two adjacent zigzag shaped structures are spaced a distance that is ranged from
$$0.03 mm to 0.1 mm .$$
